(19) United States
(12) Patent Application Publication
(10) Pub. No.: US 2003/0188633 A1
(43) Pub. Date: Oct. 9, 2003

(54) Piston for internal combustion engine

(76) Inventors: Walter Joseph Griffiths, Lymington (GB); Kenneth John Street, Lymington (GB)

Correspondence Address: Robert L Stearns, 5291 Colony Drive North, Saginaw, MI, 48603, US

(21) Appl. No.: 10/363,382

(22) PCT Filed: Sep. 5, 2001
(86) PCT No.: PCT/GB01/03999

(30) Foreign Application Priority Data
Sep. 6, 2000 (GB) 0021846.1

(51) Int. Cl. F16J 1/04

(52) U.S. Cl. 92/208; 29/888.04

(57) ABSTRACT

An engine piston (10) comprising a crown (12) and a tubular body portion (30) containing gudgeon pin bosses (46) and force transmitting regions (66) has the body portion forged, preferably of steel, as two or more circumferentially incomplete segments (100₁, 100₂) which extend about a longitudinal piston axis (14) and are joined into the tubular form by welding or the like. The segments are forged in a direction perpendicularly to the piston axis which permits the formation of regions of differing wall thickness along the tubular body length and mass saving recesses (70) between force transmitting struts (66₁) and (66₂) that are not possible with forging a unitary tubular body from one end.

This invention relates to pistons and methods of making pistons. Particularly, but not exclusively, it relates to pistons for use in internal combustion engines, more particularly diesel engines.

Modern diesel engines are required to produce high efficiency and high power density, often at high revolution rates and often achieved by turbocharging, resulting in generation of high cylinder pressures and high levels of heat to be dissipated.

Although it is known to form engine pistons from light, usually aluminium based, alloys and from steel alloys, the properties of such light alloy materials that make them superior to steel for many purposes are unable to satisfy the extreme conditions in high power density engines. Notwithstanding its ability to be cast into complex, rigid and structurally strong shapes and good thermal conductivity, there is reached a point in achieving such high power density where the piston is exposed to temperatures approaching the melting point of the alloy material and thus begins to lose strength against high cylinder pressures irrespective of its structure.

Steel has a much higher melting point and, in a forged condition, is potentially capable of giving a greater strength to weight ratio, although it does exhibit some properties which have detracted from, and limited, its practicability. For example, it has a relatively poor thermal conductivity that in many instances requires the provision of supplemental liquid cooling and although capable of exhibiting greater strength for less mass in correspondingly thinner sectioned structures, it does therein tend to lack rigidity and has been used to any practicable extent only where the extra mass required to achieve a rigid structure is permissible. Furthermore, machining operations performed on steel pistons tend to be more costly and as a consequence, wholly steel pistons have tended to be employed only in large capacity, low-revving engines where the inertia of the heavy piston is outweighed by its strength and production cost is not an overriding factor.

Insofar as it is the piston crown which is subjected primarily to high cylinder pressures in operation, it is known to form a discrete forged steel crown portion, including combustion bowl cooling chambers and like features which serve to reduce the drawbacks of mass and thermal conductivity thereof, and join it to a potentially less stressed body portion that provides a tubular skirt for guidance and absorbing lateral thrusts within an engine cylinder. Such body portion may be of a less strong material but as there is still the need to couple forces exerted on the crown into a gudgeon pin of a connecting rod, the crown portion or this body portion requires to be made from maternal and/or have a structural form that accommodates this and the opportunity for achieving a low mass, high revving piston is compromised. U.S. Pat. No. 1,667,202 describes a low mass steel piston which instead of being forged from a single blank is fabricated from separate component parts, a crown portion having welded thereto separate gudgeon pin bosses for force transmission and semi-circular sheet steel skirt shells bent to shape and welded to each other and to the crown and bosses to form the finished piston. Its objective is to achieve a low cost method of manufacturing steel pistons from component parts, steel being suited to the thin wall bending operations that provide the skirt shells, but this construction results in a piston having thin-sectioned parts of low rigidity and welded joints in the path of transmitted forces that preclude its use in high power density situations.

As mentioned above it is known to manufacture a piston from form components other than steel and to this end U.S. Pat. No. 2,244,008 describes a piston made from separate light alloy components, the components being machined and. assembled into the finished piston. The skirt of this piston is made in separate component parts to enable a cooling chamber to exist within the internal structure of the piston, but nevertheless demonstrates a complex and massive crown portion which is responsible for transmitting combustion chamber forces directly to integral gudgeon pin bosses and need to completely machine this piston to the desired tolerance limits, and notwithstanding unsuitability of the materials within a high power density, high temperature environment, demonstrates that such construction is an expensive form of manufacture.

Accordingly, the use of steel in engine pistons has in practice been confined to forging integral or discrete crown and tubular body portions by direct forging along what is to be the longitudinal piston axis in a direction from the open skirt end to a closed crown end, such forging having a benefit in respect of integrally forging projections from the side wall to form gudgeon pin bosses and the draw angle of the forging tooling creating greater wall thickness and strength towards the crown end of the tubular body, including the ability to transmit crown forces to the gudgeon pin, but also the drawback that such draw angle thickening and any projections internally towards the longitudinal axis result in a considerable bulk of metal between such projection and the closed end of the forging and to a larger mass than dictated by the strength of the material.

It is possible to reduce the weight of such a body component by machining re-entrant features in the internal tubular wall of the piston after forging has taken place but this removal of metal and formation of re-entrant features is not without difficulty, in view of the need to transfer significant forces between parts of the piston, particularly the crown and gudgeon pin bosses, and the cost of selectively removing distributed regions of metal by internal machining is relatively high in a unitary forging and prohibitively so in many but not all, cases.

Thus irrespective of the manner of manufacture, there does not exist a forged piston structure that is applicable to a steel crowned piston capable of low mass and simple and cost effective. manufacture, and it is an object of the present invention to provide a strong low mass forged piston and a method of making a piston by forging that is more cost effectively implemented than hitherto.

According to a first aspect of the present invention an engine piston comprises a substantially circular crown having a periphery generated about a longitudinal piston axis, and, extending from the crown portion surrounding said longitudinal axis, a forged body portion having a tubular side wall that forms a piston skirt open at one end remote from the crown and substantially closed at the crown end, said tubular side wall extending longitudinally of the piston axis between said open and crown ends and bisected by a thrust plane including said piston axis, a pair of gudgeon pin bosses formed integrally with the side wall, each boss extending from the side wall spaced from the open and crown ends along a substantially diametric pin axis perpendicular to the thrust plane towards the other boss and spaced apart therefrom and apertured along at least part of its length along the pin axis to provide bearing support for a gudgeon pin, and a plurality of force transmitting struts forged integrally with each boss and extending axially from the boss to the crown end, each strut extending along the boss to the side wall and to a limited extent across the boss to define at least one radially open gallery between the boss and the crown end.

The term “gallery” is used herein to refer to a space overlooking the inboard end of the gudgeon pin boss and not within the narrower context of a liquid conveying duct or container, not that such possibility is excluded.

Preferably, the crown and body portion comprise discretely formed portions, and the crown end of the body portion comprises a body end wall of the portion disposed overlying, and secured with respect to, a force transmitting face of the crown portion.

Preferably, the body portion comprises a plurality of body segments each defined by a side wall part, curved about a longitudinal segment axis coincident with the piston axis and extending circumferentially between longitudinally extending boundary edges, and an end wall part extending about said segment axis between substantially radially extending boundary edges, said segments being joined together along the boundary edges and at least two of the segments, facing each other across the piston axis, each including a gudgeon pin boss and associated force transmitting struts.

Conveniently, the crown and body portions are each made of steel. However, having defined a piston structure that permits the use of steel advantageously, it is not limited thereto and available to other materials that can be forged in corresponding manner.

According to a second aspect of the present invention, a method of making an engine piston, having a crown defined about a piston axis and a body portion, extending with respect to the crown along the piston axis, having a tubular side wall that forms a piston skirt extending between an open end and a substantially closed crown end defined by a body end wall, comprises

forming at least the body portion as a plurality of body segments defined by side wall parts curved about a longitudinal segment axis and having longitudinally extending boundary edges,

forming two segments each with a gudgeon pin boss integral with the side wall part and joining the segments along the boundary edges such that segment axes coincide and define the piston axis, and the gudgeon pin bosses oppose in substantially diametric alignment perpendicularly to the segment axis and define a gudgeon pin axis,

forging each of said two segments from a steel blank along a forging axis perpendicular to the segment axis and therein forging a said boss and a body end wall part to a greater thickness in the forming direction than at least one radially open gallery region between the boss and body end wall part.

Conveniently, the method comprises forming said two segments with gudgeon pin bosses identical with each other, preferably forming said body portion from two segments with gudgeon pin bosses having side wall parts extending substantially 180° about the segment axis.

Preferably, the method comprises forging the body end wall part of the segment extending radially with respect to the segment axis and joining said segments to each other along the boundary edges between side wall parts and end wall parts.

The boundary edges are preferably joined by a metallurgical bond and may be joined by welding or by diffusion bonding.

Embodiments of the invention will now be described by way of example with reference to the accompanying drawings, in which:

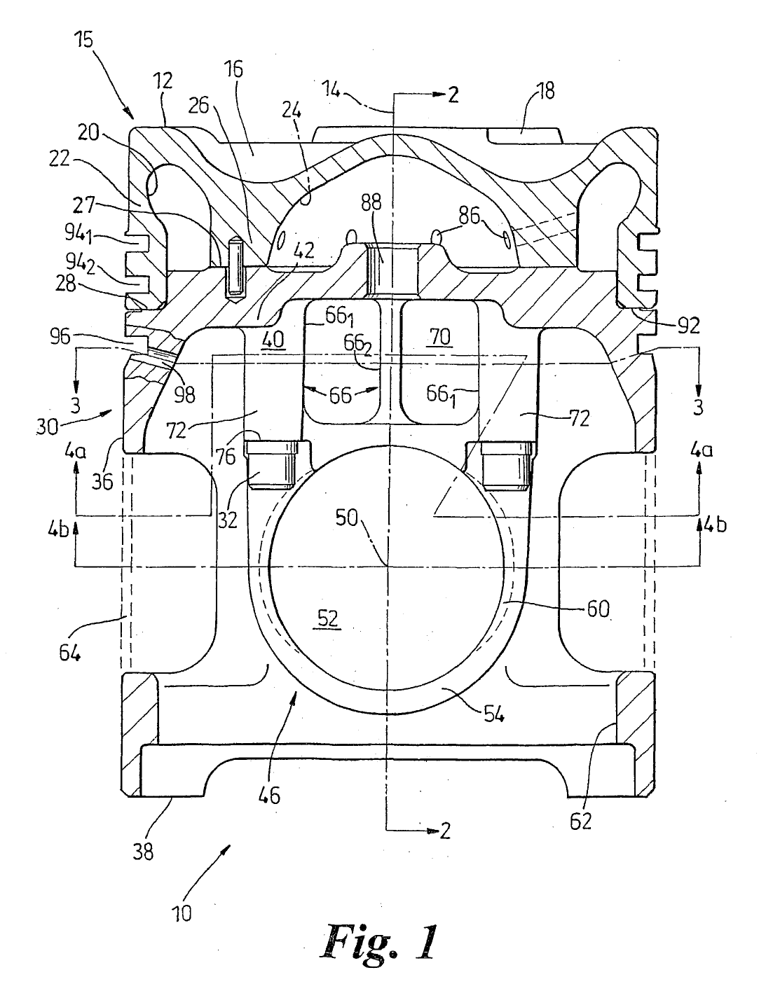

FIG. 1 is a sectional elevation through one form of piston according to the invention, comprising discrete forged crown and body portion bolted together, the body portion having a substantially closed crown end wall that defines, with crown recesses, a plurality of cooling chambers, integral gudgeon pin bosses and force transmitting struts and mass saving galleries between the bosses and the crown end wall,

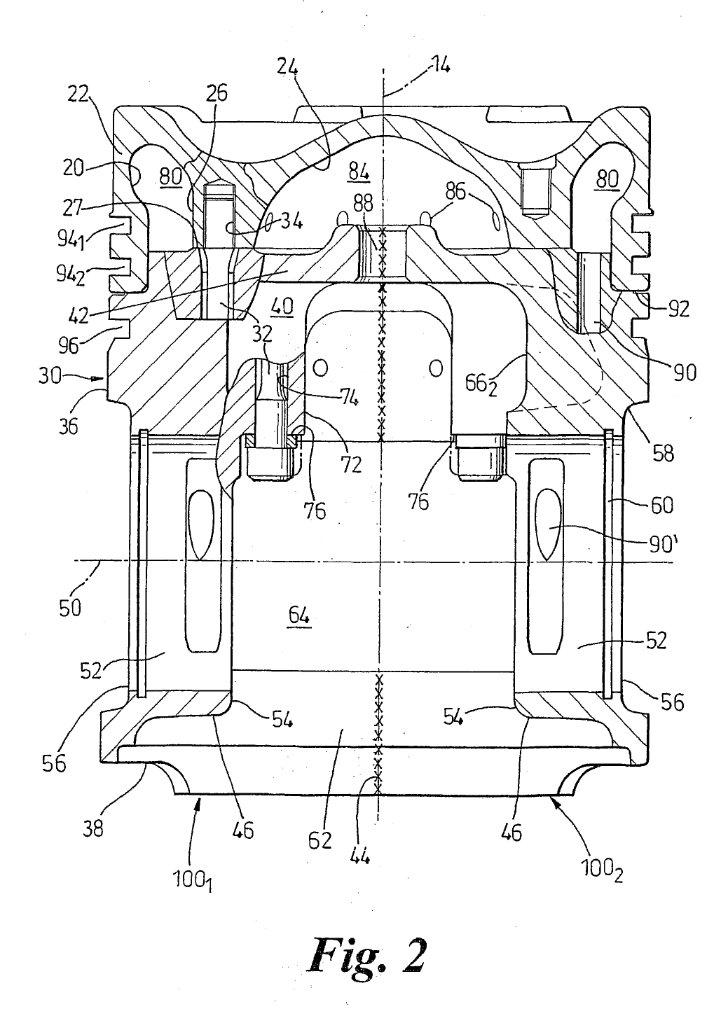

FIG. 2 is a sectional elevation through the piston of FIG. 1 along the line 2-2 thereof, illustrating radially recessed gudgeon pin bosses and mass saving reduction in the tubular side wall at the end of the bosses,

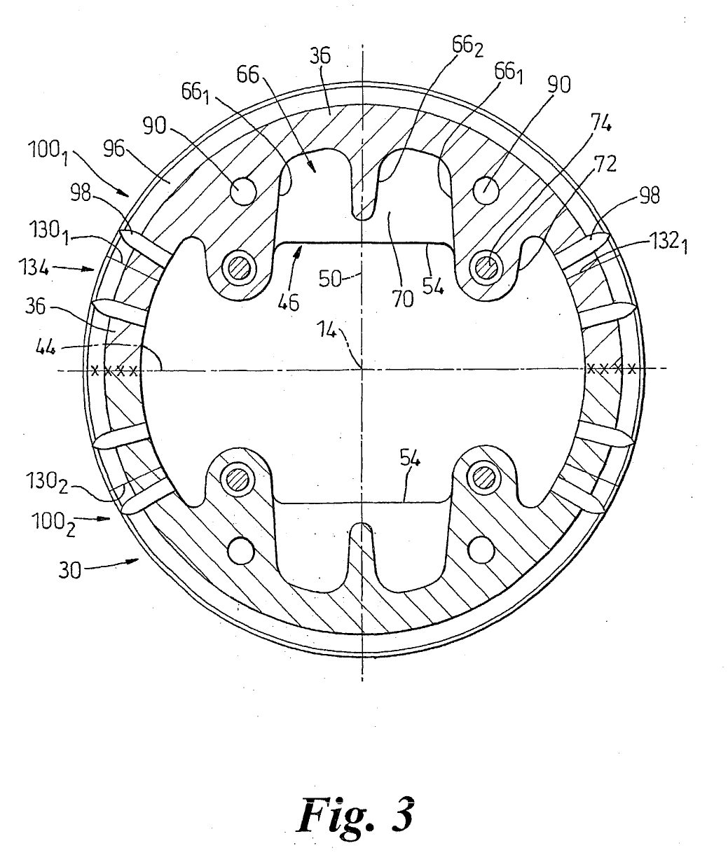

FIG. 3 is a cross section through of the piston of FIGS. 1 and 2, along the line 3-3 thereof, illustrating particularly the force transmitting struts and mass saving galleries, and

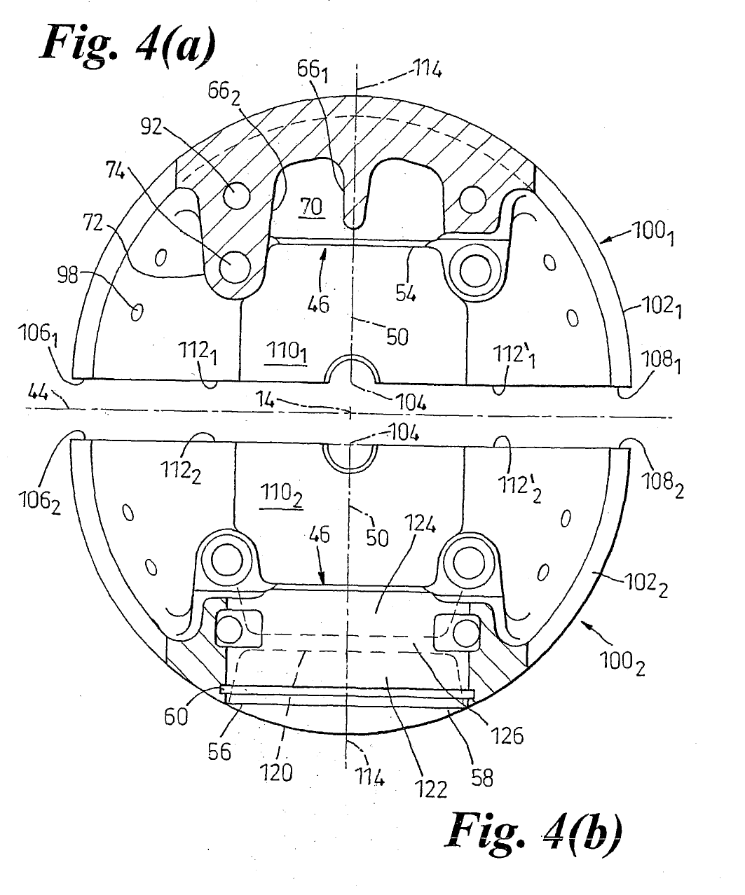

FIGS. 4(a) and 4(b) are cross sections through component segments of the body portion of the piston of FIGS. 1 and 2 at the levels 4a-4a and 4b-4b thereof respectively, illustrating manufacture of the portion.

Referring to the Figures of the drawings. there is shown an engine piston 10 comprising a crown 12 having a periphery generated about a longitudinal piston axis 14. The crown is a discrete portion 15 of the piston and forged from steel. The upper surface of the crown portion has a recessed combustion bowl 16 and valve pockets 18 whereas the lower surface is formed as an axially open annular recess 20 adjacent the peripheral, ring carrying wall 22 and an axially open central recess 24 separated from the recess 20 by an annular, force transmitting rib 26. The rib 26 has a thrust face 27 in a plane perpendicular to the piston axis 14 and is, in the direction of the axis, recessed with respect to the axial end 28 of the peripheral wall 22.

The crown portion 15 is connected to a forged steel tubular body portion 30 by a plurality of bolts 32 received in threaded apertures 34 in the force transmitting face 27 of the rib 26, as described further hereinafter. The body portion 30 extends from the crown portion surrounding the longitudinal piston axis 14 and has a tubular side wall 36 that forms a piston skirt open at one end 38 remote from the crown and substantially closed at the crown end 40 by a body end wall 42. The tubular side wall extends longitudinally of the piston axis between said open and crown ends and is bisected by a thrust plane 44 including the piston axis, that is, the plane of the drawing of FIG. 1 and perpendicular to the plane of the drawing of FIG. 2.

The body portion 30 also comprises a pair of gudgeon pin bosses 46 formed integrally with the side wall 36 and extending from the side wall towards each other, along a substantially diametric pin axis 50 perpendicular to the longitudinal axis 14 and thrust plane 44, and are spaced apart from each other and from the open end 38 and crown end 40. Each gudgeon pin boss 46 has an aperture or bore 52 to provide, along part of its length, bearing support for a gudgeon pin (not shown). The proximal, inboard ends 54 of the bosses are substantially parallel to each other and to the thrust plane.

Insofar as the pin bosses are formed integrally with the tubular side wall and represent a local thickening thereof, the distal, or outboard, ends 56 of the gudgeon pin apertures 52 and wall regions 58 surrounding the aperture ends are recessed with respect to the outer surface of the side wall 36. Said regions contribute a mass saving reduction in the metal content of the piston. The extent of recessing is not insignificant as the use of steel, with its superior strength, permits the use of relatively short length bearing support from aperture 52. Adjacent the outboard ends of the pin apertures grooves 60 are formed for pin retaining circlips (not shown).

Between the open end 38 and the bosses 46, the side wall 36 has an internal thickening which defines a strengthening band 62 extending about the periphery of the body portion. The strengthening band 62 provides sufficient strength and stiffness in the side wall of relatively resilient steel to enable the side wall to have, circumferentially between the pin bosses and axially spaced from the strengthening band 62 and end wall 42, a mass saving region 64 of reduced wall thickness centred on the thrust plane 44. In this embodiment the wall thickness is reduced to zero so that each said region comprises a through aperture. Thus, notwithstanding the additional mass of the strengthening band 62, the reduction from regions 64 is able to more than compensate.

In addition to mass saving metal reduction in the regions 58 and 64, the structure of the body portion between the bosses 46 and body end wall 42 also contributes to reduced piston mass.

Setting aside the manufacture, discussed below, a plurality of force transmitting struts 66 are formed integrally with each pin boss 46 and extend axially from the boss to the crown end of the body portion, being there integral also with the body end wall 42. Each strut also extends along the boss, in a direction perpendicular to the thrust plane 44, to the side wall 36 and to a limited extent across the boss to define at least one radially open gallery 70 overlying the boss. In this embodiment, each boss has associated therewith a pair of struts 66₁ disposed symmetrically each side of the pin axis and substantially each side of the pin aperture or bore 52, although the struts are wider in said direction across the boss so that they overlie a part of the bore. Between the struts 66₁ is, optionally, one or more struts 66₂ which sub divide the open gallery 70.

Each strut 66₁ extends away from the side wall towards the thrust plane beyond the inboard end 54 of the pin boss to form a lug 72. This lug has a through aperture 74 extending in a direction parallel to the piston axis to receive an aforementioned bolt 32 and, at the end displaced longitudinally from the crown end, a tightening surface 76 against which the bolt head can bear.

The crown portion and body portion are disposed with respect to each other with the body end wall 42 abutting the force transmitting rib 26, overlying the face 27 thereof, and with the bolts 32 extending through the apertures 74 in the lugs 72 and into the threaded apertures 34, being tightened against surfaces 76 to clamp the body portion to the crown portion.

The body end wall 42 also overlies the annular and central recesses 20 and 24 and defines thereby closed coolant chambers 80 and 84. A plurality of transverse ducts 86 extend through the force transmitting rib 26 permitting liquid coolant, in the form of lubricating oil of the engine, to flow from the annular chamber 80 into the central chamber 84. A central drain aperture 88 through the body end wall permits said coolant oil to escape into the body space. A plurality of feed apertures 90 extend between the gudgeon pin boss bores at 90′ and the annular chamber 80 through the outer struts 66₁ in a direction parallel to the piston axis, whereby in operation, lubricating oil pumped at elevated pressure to the gudgeon pin boss bore has a proportion thereof pass to and through the annular chamber to assist in conducting heat from the crown face and periphery.

At the junction between the body end wall 42 and tubular side wall 36, shoulder means 92 locates the axial end of the peripheral wall 22, the body end wall 42 being thus disposed substantially within the periphery of the crown portion. The peripheral wall 22 contains a plurality of circumferentially extending piston ring grooves 94₁ and 94₂, one of them being shown in a region of the peripheral wall overlying the shoulder means and thus supported by body end wall 42. A circumferentially extending oil control ring groove 96 is defined in the outer surface of the tubular wall 36 and a plurality of oil drainage ducts 98 extend through the side wall into the regions, each side of the thrust plane 44, between the thrust plane and struts 66₁.

In addition to the above features, the tubular side wall 36 is, between said struts and centred on the thrust plane, of substantially uniform thickness circumferentially of the wall. Such uniformity of wall thickness and said radially open galleries 70 provide a further saving in mass that results from the manufacture of the body portion by forging in accordance with the present invention when compared with known forged constructions.

Referring also to FIGS. 4(a) and 4(b), the body portion 30 comprises a pair of identical body segments 100₁ and 100₂ each defined by a side wall part 102₁ and 102₂ that is curved substantially cylindrically about a longitudinal segment axis 104, coincident with piston axis 14, and extends circumferentially for 180° about this segment axis between longitudinally extending boundary edges 106₁ and 108₁ and 106₂ and 108₂ respectively. Each segment is also defined by one end wall part 110₁, 110₂ extending about the segment axis 104 between boundary edges 112₁ and 112′₁ and 112₂ and 112′₂ respectively, also subtending an angle of 180° between them.

Each segment includes an aforementioned gudgeon pin boss and force transmitting struts extending between the boss and the end wall part 110₁ etc. and is defined centred on the gudgeon pin axis, which extends radially with respect to the side wall part and through the segment axis. It will be appreciated that insofar as the segments are identical the bosses of the juxtaposed segments will define a diametric pin axis.

The segments 100₁ and 100₂ are joined to each other along the boundary edges 106₁, 106₂, 108₁, 108₂, 112′₁, and 112′₂, 112₁ and 112₂ by bonding, preferably metallurgically and conveniently welding or diffusion bonding.

As most clearly seen from FIGS. 4(a) and 2, each segment, such as 100₁, is formed by forging from a steel blank along a forging axis 114 perpendicular to the segment axis 104 and in said forging defines the boss 46 and body end wall part 110₁ to a greater thickness in the forging direction, that is, the open gallery region 70 between the boss and end wall part of the segment, as well as force transmitting struts 66₁ and 66₂.

Insofar as each segment is formed by a forging operation, the side wall part, upstanding boss and force transmitting struts all require a small, but significant draw angle taper which may lead to a “thickening” of any component in a direction transversely to the forging axis. However, in this embodiment, it will be seen that the struts 66 extend for a relatively short distance from the side wall in the forging axis direction and the side wall part itself, in forming a sector of a circle, has a curvature naturally defining a draw angle. Accordingly it is possible to forge such structure with very little extraneous metal and a side wall 36 of substantially uniform thickness, except of course where interfacing with boss 46 or struts 66. This manifests itself particularly towards the closed end 40 of the body portion where, as seen in FIG. 3, the well defined side wall and struts that are not dictated by a longitudinal draw angle permit the drain apertures 98 to be located throughout a significant included angle.

Furthermore, by forging along an axis 114 that is substantially coincident with the gudgeon pin axis 50 through the boss it is possible also as part of the forging operation to create, at least to a rough finish the boss apertures or bores 52 and the external recess 58, thereby relieving the extent of subsequent machining and waste material. As shown in FIG. 4(b) by broken lines 120 the bore 52 may be rough forged from the opposite sides of the part wall of the segment as two blind recesses 122, 124 separated by a transverse diaphragm 126 which prevents contact between the parts of the forging tooling but is easily removed during machining of the pin-aperture.

Thus, it will be appreciated that in comparison with forging the body portion as a unitary structure along the longitudinal piston axis 14 that corresponds to longitudinal segment axis 104, wherein it is not possible to form any radially re-entrant features such as the open galleries 70 between bosses and closed end wall and side wall thickness reduction between a thickened strengthening band 62 and the closed end but only a tapered thickening of the side walls approaching toward the closed end because of the accumulation of draw angle over such longitudinal forging distance, such forging as segments along a forging axis transversely to the longitudinal segment axis permits the production of mass saving features and of structural forms substantially by said forging alone and in any event without complex machining.

Although it is considered preferable that the many features in each segment which can be produced during the forging are, there will be need for some machining before or after joining the segments into a body portion, for example to define internal apertures for gudgeon pins, securing bolts and coolant ducts, a well as external dimensions, and it is an added advantage of this construction that many of the forgeable features may also be produced by relatively simple and inexpensive machining having complete access along the forging axis 114, giving greater flexibility to manufacturing and the economies thereof.

The above described piston construction is optimised for steel but it may be employed with a forgeable light alloy material having regard, in shapes and dimensions, to the different mechanical and thermal properties of the materials. As mentioned above, it is known to have such discrete crown and body portions of different materials and it is foreseen to form a crown portion of steel and the body portion of a light alloy material.

Although the invention has been described above with regard to having discrete crown and body portions, the latter being made by forging and joining segments, it may be possible to incorporate a crown within the body end wall such that the crown itself is defined by said segments and each joint between segments extends over the crown. Whereas having axially separate crown and body portions facilitates easy formation of cooling chambers 80 and 84, from simply formed recesses, it is possible to effect radially open galleries, in the manner of gallery 70, which may be formed in to a radially bounded chamber suited to the temporary holding of cooling oil by means of a separate tubular or cup-like insert and/or may be axially bounded by a transverse plate.

Although the gallery 70 is radially open as a result of its formation and function as a mass reducing absence of metal, the opening may be closed off to a desired degree by a separately mounted wall member if there is a requirement to contain cooling liquid or the like therein.

Although within the above described embodiment the struts 66₁ and lugs 72, with bolt apertures 74, extend parallel to the piston axis it will be appreciated that the struts and/or bolt apertures may be inclined with respect to such axis, subject to forging, to define particular force transmission paths between crown and gudgeon pin bosses or accessibility to the bolts. Furthermore, whilst it is convenient to secure the discrete crown and body portions by bolts 32, it may also be possible to effect a permanent metallurgical bond between the portions at the shoulder means 92, and rely upon abutment at the rib face 27 for transmitting what are primarily compressive forces, or have both.

It will be appreciated that the fact that the body portion can be formed of a small number of identical parts further aids cost effectiveness. Constructing the body portion 30 from two segments is particularly convenient, although the junction between them then lies in the thrust plane of the piston. However, insofar as forces acting thereon are relatively small, compared with those acting through the crown, this is not seen as particularly disadvantageous.

The body portion may be formed of more than two segments, provided that at least two of the segments have the gudgeon pin bosses and force transmitting struts and are capable of disposition facing each other across coincident segment axes to define the gudgeon pin axis. It may, for example, be possible to define the body portion from four segments. With reference to FIG. 3, it will be seen that each segment 100₁ and 100₂ may extend about the segment axis only to the extent necessary to subtend an angle which includes a pin boss and associated struts, having, say longitudinal boundary edges 130₁, 132₁ and to have simple segments 134 between boss carrying segments, said simple segments both providing any reduction in wall thickness (64) and serving to offset the joints between segments from the thrust plane 44.

1. An engine piston comprising a substantially circular crown having a periphery generated about a longitudinal piston axis, and, extending from, the crown portion surrounding said longitudinal axis, a forged body portion having a tubular side wall that forms a piston skirt open at one end remote from the crown and substantially closed at the crown end, said tubular side wall extending longitudinally of the piston axis between said open and crown ends and bisected by a thrust plane including said piston axis, a pair of gudgeon pin bosses formed integrally with the side wall, each boss extending from the side wall spaced from the open and crown ends along a substantially diametric pin axis perpendicular to the thrust plane towards the other boss and spaced apart therefrom and apertured along at least part of its length along the pin axis to provide bearing support for a gudgeon pin, and a plurality of force transmitting struts forged integrally with each boss and extending axially from the boss to the crown end, each strut extending along the boss to the side wall and to a limited extent across the boss to define at least one radially open gallery between the boss and the crown end.

2. A piston as claimed in claim 1 in which the crown and body portion comprise discretely formed portions, and the crown end of the body portion comprises a body end wall of the portion disposed overlying, and secured with respect to, a force transmitting face of the crown portion.

3. A piston as claimed in claim 2 in which the crown portion includes at least one axially open recess adapted to be substantially closed by the crown end of the body portion defining therebetween at least one chamber, and the crown end of the body portion includes at least one coolant aperture extending therethrough in line with each recess comprising a coolant duct connecting the chamber to the body portion.

4. A piston as claimed in claim 3 in which at least one said coolant aperture extends through a strut from the gudgeon pin boss to the crown end.

5. A piston as claimed in any one of claims 2 to 4 in which the body and crown portions are connected to each other by a plurality of bolts extending substantially parallel to regions of the crown portion.

6. A piston as claimed in claim 5 in which each bolt has associated therewith an apertured lug operable to define a positioning feature for the bolt and a tightening surface displaced longitudinally from the crown end.

7. A piston as claimed in claim 6 in which each lug comprises, at least in part, an extension of a said force transmitting strut beyond the inboard end of a pin boss.

8. A piston as claimed in any one of the claims 2 to 7 including shoulder means between the tubular side wall and body end wall adapted to locate an axially extending periphery of the crown portion such that the body end wall portion is disposed substantially within said periphery of the crown portion.

9. A piston as claimed in any one of the preceding claims in which the body portion comprises in the tubular side wall at least one oil control ring groove and at least one drainage duct extending from said groove through the tubular wall between the thrust plane and the struts.

10. A piston as claimed in any one of the preceding claims in which the tubular side wall includes, between the open end and the gudgeon pin bosses, an internal thickening of the side wall defining a strengthening band extending about the periphery of the skirt portion.

11. A piston as claimed in any one of the preceding claims in which the tubular side wall has at least one mass saving region of reduced wall thickness centered on the thrust axis, spaced axially from the strengthening band and the closed end and circumferentially from the pin bosses.

12. A piston as claimed in claim 10 in which at least one region of reduced wall thickness comprises a through aperture.

13. A piston as claimed in any one of the preceding claims in which the end of the gudgeon pin aperture in each boss is recessed from the outer surface of the side wall.

14. A piston as claimed in claim 13 in which the outer surface of the side wall surrounding the opening of the gudgeon pin aperture is recessed relative to the remainder of the side wall.

15. A piston as claimed in any one of the preceding claims in which the proximal inboard ends of the gudgeon pin bosses are substantially parallel to each other and the thrust plane.

16. A piston as claimed in any one of the preceding claims in which the tubular side wall is, between said struts, of substantially uniform thickness circumferentially of the wall.

17. A piston as claimed in any one of the preceding claims in which there are associated with each gudgeon pin boss at least a pair of struts disposed symmetrically each side of the pin axis and substantially of the pin aperture.

18. A piston as claimed in any one of the preceding claims in which the body portion comprises a plurality of body segments each defined by a side wall part, curved about a longitudinal segment axis coincident with the piston axis and extending circumferentially between longitudinally extending boundary edges, and an end wall part extending about said segment axis between substantially radially extending boundary edges, said segments being joined together along the boundary edges and at least two of the segments, facing each other across the piston axis, each including a gudgeon pin boss and associated force-transmitting struts.

19. A piston as claimed in claims 2 to 18 in which the tubular body portion comprises a pair of semi-cylindrical segments joined together at boundary edges in the thrust plane.

20. A piston as claimed in claim 19 in which the semi-cylindrical segments are identical to each other.

21. A piston as claimed in any one of claims 18 to 20 in which the segments are bonded to each other along the boundary edges thereof.

22. A piston as claimed in any one of claims 21 in which the segment boundary edges are welded to each other.

23. A piston as claimed in claim 21 in which the segment boundary edges are diffusion bonded to each other.

24. A piston as claimed in any one of claims 18 to 33 in which the features formed within each segment all have boundaries which extend substantially perpendicular to the thrust plane in accordance with forging in a direction perpendicular to the segment axis.

25. A piston as claimed in any one of the preceding claims in which the crown and body portion are each made of steel.

26. A method of making an engine piston having a crown defined about a piston axis, and a body portion, extending with respect to the crown along the piston axis, having a tubular side wall that forms a piston skirt extending between an open end and a substantially closed crown end defined by a body end wall,
the method comprising
forming at least the body portion as a plurality of body segments defined by side wall parts curved about a longitudinal segment axis and having longitudinally extending boundary edges,
forming two segments each with a gudgeon pin boss integral with the side wall part and joining the segments along the boundary edges such that segment axes coincide and define the piston axis, and the gudgeon pin bosses oppose in substantially diametric alignment perpendicularly to the segment axis and define a gudgeon pin axis,
the method being characterised by
forging each of said two segments from a steel blank along a forging axis perpendicular to the segment axis and therein forging a said boss and a body end wall part to a greater thickness in the forming direction than at least one radially open gallery region between the boss and body end wall part.

27. A method as claimed in claim 26 comprising forming said two segments with gudgeon pin bosses identical with each other.

28. A method as claimed in claim 26 and claim 27 comprising forming said body portion from two segments with gudgeon pin bosses having side wall parts extending substantially 180° about the segment axis.

29. A method as claimed in any one of claims 25 to 28 comprising forging the body end wall part of the segment extending radially with respect to the segment axis and joining said segments to each other along the boundary edges between side wall parts and end wall parts.

30. A method as claimed in claim 29 comprising joining said boundary edges by welding.

31. A method as claimed in claim 29 comprising joining said boundary edges by diffusion bonding.

32. A method as claimed in any one of claims 25 to 31 comprising forging simultaneously with the gudgeon pin bosses, recesses therein forming the basis for said gudgeon pin apertures.

33. A method as claimed in claim 32 comprising forging with each said gudgeon pin boss a pair of recesses from opposite sides of the segment separated by a diaphragm of steel.

34. A method as claimed in any one of claims 26 to 32 comprising forging with each said open gallery region at least one force transmitting strut extending between the boss and body end wall of the segment.

35. A method as claimed in claim 34 comprising forging an extension of at least one strut along the forging axis closer to the segment axis than the end of the boss and defining through the strut extension a bolt-locating through aperture extending parallel to the segment axis.

36. A method as claimed in any one of claims 26 to 35 comprising forming in a said strut a coolant duct as a through aperture between said gudgeon pin boss pin aperture and said end wall of the segment.

37. A method as claimed in any one of claims 26 to 36 comprising forming a discrete crown portion and body portion and securing the crown end wall of the body portion to the crown portion.

38. A method as claimed in claim 37 comprising defining the crown portion with at least one recess open in the direction of the piston axis and substantially closing said recess by said crown end wall to define a chamber by securing said body piston to the crown portion.

39. A method as claimed in claim 38 comprising defining an annular recess adjacent a periphery of the crown portion and a central recess separated therefrom by an annular, axially facing force transmitting rib and abutting the crown end wall of the body portion against the end of said rib to effect closed chambers from said recesses.

40. A method as claimed in any one of claims 36 to 39 comprising defining in at the junction of the side wall and body end wall of the body portion a shoulder and locating the crown thereto by way of its periphery.
